(19) United States
(12) Patent Application Publication
(10) Pub. No.: US 2010/0036537 A1
(43) Pub. Date: Feb. 11, 2010

(54) METHOD FOR PRODUCTION OPTIMIZATION IN AN OIL AND/OR GAS PRODUCTION SYSTEM

(75) Inventors: Hans Petter Bieker, Oslo (NO); Olav Slupphaug, Oslo (NO)

Correspondence Address: VENABLE LLP, P.O. BOX 34385, WASHINGTON, DC, 20043-9998, US

(73) Assignee: ABB AS, Billingstad (NO)

(21) Appl. No.: 12/441,492

(22) PCT Filed: Sep. 17, 2007
(86) PCT No.: PCT/IB2007/002678

§ 371 Date: Mar. 16, 2009

Related U.S. Application Data
(60) Provisional application No. 60/844,638, filed on Sep. 15, 2006.

(30) Foreign Application Priority Data
Sep. 15, 2006 (NO) 20064191

(51) Int. Cl. G05B 13/04; G05D 7/06; G06G 7/57

(52) U.S. Cl. 700/285; 703/9; 700/282; 700/29

(57) ABSTRACT

A method for production optimization in an oil and/or a gas production system. The system including at least two flow sources leading to at least one common downstream flow line, and at least one manipulated variable of the production system. The method includes use of a computational model of the production system including an interdependence between flow rates of the flow sources and a flow rate of the downstream flow line, and values of the manipulated variable; a feasible set defined by at least one constraint of the manipulated variable, and an objective function, to be optimized within said feasible set, defined by using the computational model. The method includes splitting by calculation the feasible set into at least two subsets, calculating, for each of the subsets, a best bound of the objective function by using the computational model, and manipulating the manipulated variable by using the best bound to optimize the oil and/or gas production.

### TECHNICAL FIELD OF THE INVENTION

The present invention relates to a method for production optimization in an oil and/or a gas production system comprising: at least two flow sources leading to at least one common downstream flow line, and at least one manipulated variable of the production system, wherein the method comprises use of: a computational model of the production system comprising an interdependence between flow rates of said flow sources and a flow rate of the downstream flow line, and values of the manipulated variable; a feasible set defined by at least one constraint of the manipulated variable, and an objective function, to be optimized within said feasible set, defined by using said computational model.

The present invention also relates to a system for optimization of oil and/or gas production according to the preamble of the independent system claim, and a computer program product for executing one or more steps according to the inventive method.

The inventive method is preferably used in decision-making for oil and/or gas production systems comprising a network of flow lines. The term “production optimization” includes the use of optimization algorithms for supporting operations on a second-to-second to a year-to-year basis by computing, for example, optimal values or settings of manipulated variables for flow rates, choke openings, control valve openings, pressures, temperatures, or fluid compositions throughout the production system for monitoring and/or control purposes. Typically, the production system is a multiphase flow system in which phases such as water, oil, gas, and mixtures thereof are transported from a plurality of wells to a production separator.

### BACKGROUND OF THE INVENTION

An oil and/or a gas production system typically comprises a plurality of wells. A well is a pipe, or flow line, with perforations at the end, enabling an extraction of oil and/or gas from a reservoir. Each well typically has a production choke. The production choke may be used to adjust the production of each individual well. The wells are connected to a production manifold where the production from the wells is blended. The production manifold is connected to a production separator by a downstream flow line. At the downstream flow line there may be provided a further choke, enabling a control of the pressure or flow from the wells. In some systems, the downstream flow line is a short pipe. In other systems, the downstream flow line may extend several kilometers along the seabed, typically ending in a riser which connects to a platform, where processing of the fluids, exiting the flow line, takes place by using processing facilities such as: separators, heat exchangers, compressors, pumps, hydro cyclones, scrubbers, etc. For a person skilled in the art, it is common knowledge that there may be more than one production manifold, and that the production from one production manifold may be sent to a second one using various flow lines.

The production from a well is typically a mixture of oil, gas, and water phases. A production separator may separate the phases of such a mixture, whereby the oil, gas, and water exit the separator through respective outlets with associated pipes. Typically, the separation is not perfect, thereby requiring that a plurality of production separators being used in order to improve separation.

The gas pipe may be connected to a gas compressor, which increases the pressure of the gas. The gas compressor is connected to various users of the gas. Examples of users are flow lines used for the purpose of directing lift gas into different wells, or flow lines for the injection of gas or water into the reservoir. A gas export flow line may also constitute a user.

Typically, the production separator pressure is controlled by the means of automatic feed back control, using pressure measurement devices, pressure controllers, and compressor speeds, chokes, or control valves.

Each gas lift flow line is used to increase the oil production from the associated well. It works by decreasing the average density of the fluid from said well. The reduced average density may increase the production due to reduced gravitation-induced pressure drop.

In the daily operation of an oil and/or gas production system, many decisions have to be taken. One of them includes which openings or positions to use on the production choke, said further choke, and/or the lift gas valve. The positions to choose are often the ones that result in some sort of economic optimum or highest oil production rate. Typically, due to limited compressor capacity in a gas compressor, limited treatment capacity in a production separator, or limited flow capacity in the network of flow lines for gathering the production form the wells, an optimization method is often used. It allows finding the optimal trade off. Several studies have been made, resulting in the development of methods that use a mathematical description of the oil and/or gas production system, and makes it possible to calculate the oil production rate for each combination of the chokes or valves or other means for control.

A general technique used in the oil and gas industry is derivative-based nonlinear methods. The pressure drop in each well and downstream flow line is calculated based on a chosen pressure at the production manifold, on the flow rates from the well, and on the flow rates of gas lift in the lift gas pipes. A Jacobian matrix is calculated with respect to these variables, and a change in said variables is chosen giving the highest increase in total oil production, while staying within some constraints given by the user. The pressure at the production manifold is ensured to be equal to the one calculated at the outlet of the individual well by means of a constraint or a penalty function. The steps above are then repeated until some convergence conditions are met. Examples of such methods are the Successive Linear Programming or Successive Quadratic Programming.

Instead of using derivative information genetic methods have been used. By imitating natural selection, good values of the gas lift rates and the oil rates may be found.

A study, presented by Fang and Lo in “A Generalized Well-Management Scheme for Reservoir Simulation,” paper SPE 29124 presented at the 13th SPE Symposium on Reservoir Simulation, San Antonio, Tex., U.S.A., 1996, discloses the use of piecewise affine gas lift performance curves of each well to find the optimal gas lift rates subject to a constraint on gas handling capacity. A piecewise affine curve is often called a piecewise linear curve, but strictly mathematically speaking the more general term affine should be used instead of linear since linear means that the associated lines (the ones making up the piecewise affine curve) must intersect origo. This is normally not the case for most piecewise affine functions. A linear programming framework was hereby used. In the paper it is mentioned that a mixed integer linear program may be useful for wells which are not naturally flowing meaning that the reservoir pressure is too low to “lift” the well fluid out of the well to the processing facilities without lift gas. However, the method can only be used for the simplest oil and gas production system configuration due to missing support for flow lines shared by multiple wells.

In Handley-Schachler, McKie, and Quintero, “New Mathematical Techniques for the Optimization of Oil & Gas Production Systems,” paper SPE 65161 presented at the SPE European Petroleum Conference, Paris, France, 2000, it has been proposed to use a combination of piecewise affine models of the wells and a twice differentiable nonlinear model of the pressure drop in downstream flow lines. Thereby, problems associated to the use of a modified successive linear programming method are remedied.

A drawback of the prior art methods mentioned above is their inability of providing a globally optimal solution in an oil and/or gas production system, while accounting for the interaction between the productions of each well typically due to pressure interaction. Thus, the methods use an inaccurate model or provide only locally optimal solutions for such systems. There might exist several locally optimal solutions. The one chosen by a locally optimal method depends on where the search is started. No information about how far it is from the globally optimal solution—the best of all the locally optimal solutions—is provided, and this is crucial information.

### OBJECTS OF THE INVENTION

An object of the invention is to increase the oil production rate of an oil and/or gas production system.

Another object of the invention is to increase the profitability of an oil and/or gas production system.

A further object of the invention is to improve the operations of an oil and/or gas production system.

Yet another object of the invention is to present a method for providing optimal values or settings of manipulated variables for flow rates, choke openings, control valve openings, pressures, temperatures, or fluid compositions throughout the production system for monitoring and/or control purposes in an oil and/or gas production system

### SUMMARY OF THE INVENTION

These and other objects of the invention are achieved by means of a method for production optimization in an oil and/or gas production system comprising at least two flow sources leading to at least one common downstream flow line, and at least one manipulated variable of the production system. The method comprises use of: a computational model of the production system comprising an interdependence between flow rates of said flow sources and a flow rate of said downstream flow line, and values of said manipulated variable; a feasible set defined by at least one constraint of said manipulated variable, and an objective function, to be optimized within said feasible set, defined by using said computational model. The method is characterized in that it comprises the steps of:
splitting by calculation said feasible set into at least two subsets,
calculating, for each of said subsets, a best bound of said objective function by using said computational model, thereby allowing finding a bound of how good it is possible to get the objective function by adjusting a manipulated variable within the defined feasible set, and
manipulating or adjusting said manipulated variable by using said best bound to optimise said oil and/or gas production.

Preferably, a worst bound of the objective function within the feasible set is calculated using an element or a value within the feasible set, thereby allowing finding at least how good it is possible to get an objective function by adjusting a variable within the defined feasible set.

Preferably, the method is terminated when the difference between the worst bound (or limit) and the best bound (or limit) is less than a predetermined value. If the value is within the feasible set and the corresponding value of the objective function is better than the current value of the worst bound the worst bound of the objective function is being updated.

Preferably, the best bound is calculated using a relaxation of the objective function, the feasible set and/or at least one of the subsets, thereby allowing the best bound to be easily calculated with a guarantee. The relaxation is solved by an optimization problem where the objective function is guaranteed to be better (i.e. larger for maximization or smaller for minimization) within the feasible set, and where the feasible set for the relaxed optimization problem is guaranteed to include all points in the feasible set of the original optimization problem.

Preferably, a pressure is approximated in the computational model using at least one of the flow rates, thereby allowing for calculating the interaction of the flow from the flow sources due to the changed backpressure of the downstream flow line.

Preferably, the pressure is at a point where flows from said sources are blended, thereby allowing pressure equality in said point. The computation model preferably comprises a pressure at the blending point and a flow rate of the downstream flow line, and/or a pressure at the blending point and a flow rate for each of the flow sources.

Preferably, the computational model is piecewise affine, thereby allowing for easy calculation of best bounds.

Preferably, the method comprises the further steps of: further splitting by calculation at least one of the subsets into additional subsets using the best bound, thereby allowing for finding a best bound which is not different from the optimal value of the objective function within the feasible set, or where the gap can be arbitrarily small.

Preferably, the objective function uses at least one of said flow rates, thereby allowing for maximization of the total oil production rate.

Preferably, at least one of the flow sources is a well, thereby allowing production optimization from wells.

Preferably, at least one of the flow sources is an upstream flow line, thereby allowing multiple production manifolds.

Preferably, the method includes a constraint on a flow rate, a choke opening, a control valve opening, a pressure, a temperature, a fluid composition, fluid velocity, pump load or speed, compressor load or speed, or hydrocyclone load, thereby allowing specifying treatment or capacity constraints.

Preferably, a choke or a valve is used for the purpose of controlling a flow and/or a pressure of the downstream flow line or at least one of the sources, thereby allowing production optimization.

Preferably, the method is used to manipulate the choke or valve, thereby using the optimal choke or valve position on the oil and/or gas production system.

Preferably, the oil and/or gas production system comprises a subsea template at which well flows are blended at the seabed, thereby allowing the optimization of offshore systems with subsea flow networks. A subsea template includes all equipment necessary to gather the production from several wells into a set of flow lines. The blended well flows may be transported by a downstream flow line to a production platform.

Preferably, the oil and/or gas production system comprises means for supplying lift gas into a well, thereby allowing optimization of gas lift.

Preferably, the method is used to manipulate the supply of said lift gas, thereby using the optimal lift gas rates on the oil and/or gas production system.

The objects of the invention are also achieved by a system for oil and/or gas production comprising:
at least two flow sources leading to at least one common downstream flow line, and means for providing at least one manipulated variable of the production system, wherein the system further comprises:
means for providing a computational model of the production system comprising an interdependence between flow rates of said flow sources and a flow rate of said downstream flow line, and values of said manipulated variable,
means for providing a feasible set defined by at least one constraint of said manipulated variable, and
means for providing an objective function, to be optimized within said feasible set, defined by using said computational model,

The system is characterised in that it comprises: means for
splitting by calculation said feasible set into at least two subsets,
calculating, for each of said subsets, a best bound of said objective function by using said computational model, and
means for manipulating or adjusting said manipulated variable by using said best bound to optimise said oil and/or gas production.

The objects of the invention are further achieved by means of a computer program product loadable into the internal memory of a processing unit in a computer based system, comprising the software code portions for performing one or more steps of the method according to the invention, when said product is run on said system, thereby allowing running it as a computer program.

The objects of the invention are also achieved by means of a computer program product stored on a computer usable medium, comprising a readable program for causing a processing unit in a computer based system, to control an execution of one or more steps of the method according to the invention, thereby allowing distributing the computer program.

The present invention makes it possible to find global optimal production rates for each of well in an oil and/or a gas production system. The global optimum is found, unlike prior art methods, without requiring a user to provide an initial solution. This makes the inventive method robust for the user.

Further advantages as well as advantageous features of the present invention will appear from the following description.

### BRIEF DESCRIPTION OF THE DRAWINGS

With reference to the appended drawings, a specific description of preferred embodiments of the invention cited as examples follows below. In the drawings:

FIG. 1 schematically shows an oil and/or a gas production system where the present invention is applied, and

FIG. 2 schematically shows a data flow in a preferred embodiment of the present invention.

### DETAILED DESCRIPTION OF PREFERRED EMBODIMENTS OF THE INVENTION

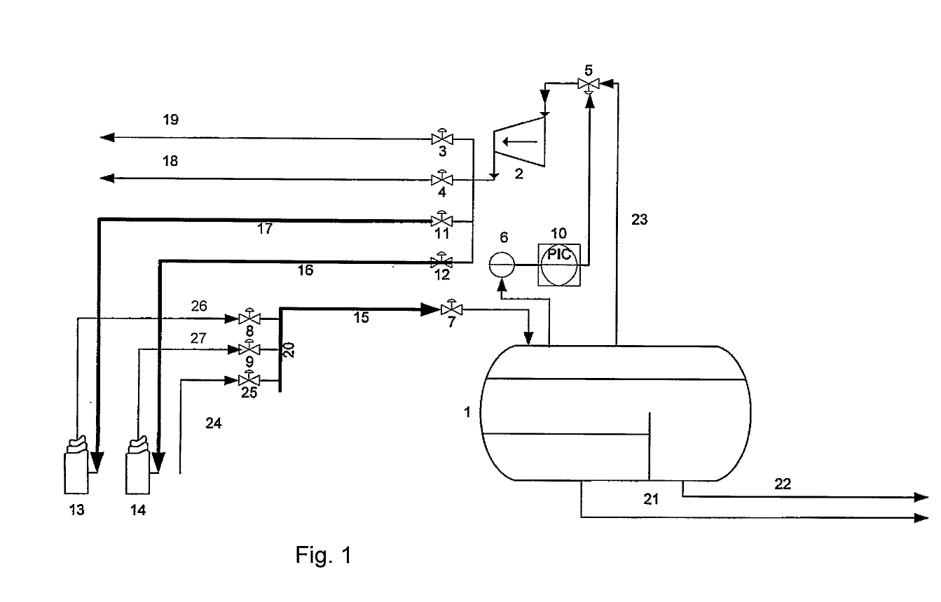

In FIG. 1 there is schematically shown an oil and/or gas a production system where the present invention may be applied.

In FIG. 1 there is shown a separator 1 for the separation of products such as oil, gas, and water obtained from an oil and/or gas well (multiphase flow). Further, there is shown a compressor 2 for compression of gas; valves or chokes 3, 4 for controlling the flow of gas from the compressor 2 to users of the gas; a valve or choke 5 for controlling the flow of gas from the separator 1 to the compressor 2; a gas pressure measurement means 6 of the production separator 1; a flow line choke 7 for controlling the flow into the separator 1; a control unit 10 comprising a computer and/or processor; valves or chokes 11, 12 for controlling a flow of gas from the compressor 2 to a respective well 13, 14; a flow line 15, leading from a production manifold 20, in which the wells 13, 14 and possible further wells or flow lines, as indicated with 24, coincide, to the separator 1; lines 16, 17 through which gas is delivered from the compressor 2 to the wells 13, 14; gas flow lines 18, 19 to remote users; a production manifold (blending point) 20 as already mentioned; a production water extraction line 21 from the separator 1, and an oil extraction line 22 from the separator 1; a gas flow line 23 extending from the separator 1 to the compressor 2; and flow lines 24, 26, 27 with associated production chokes or valves 25, 8, 9 leading to the production manifold 20.

The method according to the invention makes use of a computation model for finding the optimal oil production rates in an oil and/or a gas production system such as the one in FIG. 1. Each well 13, 14 may, preferably, be manipulated by injecting lift gas and adjusting a production choke 8, 9 associated therewith. The oil production from the wells 13, 14 may be restricted with multiple constraints in the maximum oil flow rate, water flow rate, liquid flow rate, and/or gas flow rate. The wells 13, 14 may also be restricted with a maximum total lift gas rate. In oil and/or gas production systems with subsea wells, downstream flow lines are often shared between two or more wells. The pressure in the production manifold 20 will in such configurations be affected by the flow from the wells 13, 14. Due to changing pressure conditions in the production manifold, the commonly used models based on gas lift performance curves (GLPC) will not apply to these conditions. Because of this, a model of the downstream flow lines, such as flow line 15 in FIG. 1, is also required to get more accurate results. A branch and bound approach is hereby proposed. Further, the use of a piecewise affine approximation is proposed. This makes it possible to find a proven global optimum. The problem is formulated as a mixed integer linear program and solved with a commercial branch and cut solver.

According to an embodiment of the inventive method, the method for production optimization in an oil and/or gas production system, comprising:
at least two flow sources leading to at least one common downstream flow line, wherein the method comprises use of:
a computational model comprising an interdependence between flow rates of the flow sources and a flow rate of the downstream flow line, and
an objective function and a feasible set defined by using the computational model. The method comprises the steps of: splitting the feasible set into at least two subsets, and calculating, for each of the subsets, a best bound of the objective function, preferably by solving an optimization problem derived from said objective function and said subsets, for establishing an optimum value or a setting from any of: a flow rate, a choke opening, a control valve opening, a pressure, a temperature, a fluid composition, fluid velocity, pump load or speed, compressor load or speed, or hydrocyclone load, for at least one the flow control means by using the best bound.

According to an embodiment of the inventive system, the system for oil and/or gas production optimization comprises:
at least two flow sources leading to at least one common downstream flow line, and at least one flow control means for establishing a value or a setting of a manipulated variable (decision variable), wherein said system further comprises:
means for a computational model comprising an interdependence between flow rates of said sources and a flow rate of said downstream flow line, and
   an objective function and a feasible set defined using the computational model. The system comprises: means for
splitting the feasible set into at least two subsets, and
calculating, for each of the subsets, a best bound of the objective function, and means for establishing an optimum value or a setting of a manipulated variable from any of: a flow rate, a choke opening, a control valve opening, a pressure, a temperature, a fluid composition, fluid velocity, pump load or speed, compressor load or speed, or hydrocyclone load, for at least one said flow control means by using said best bound.

### Wells

According to a preferred embodiment, a model of a well 13, 14 relates the volumetric oil rates, gas lift rates, and outlet pressure of the well 13, 14, i.e. the production manifold 20 pressure. It is preferred that the oil and gas lift rates are used as independent variables, while the production manifold pressure is the dependent (calculated) variable. Using preferably a mixed integer linear programming framework, the outlet pressure equation

pᵢ=pᵢ(qᵢ^{o},qᵢ^{lg})∀iεW (1)

for well i will be modeled, where qᵢ^{o} is oil flow rate, qᵢ^{lg} is the lift gas rate, and pᵢ is the outlet pressure of said well. Each of the independent variables is defined into a preferably finite number of break points, e.g. point in which a function evaluation of pᵢ^{O} (•) will be performed. Let the break points for oil and lift gas rates denote q_{i,k}_{^{o}}^{o} and q_{i,k}_{^{lg}}^{lg}, respectively. For the oil rate, the set Kᵢ^{o} will define the indexes of the break points, while Kᵢ^{lg} will have the same role for the lift gas rate (for each well i). A function evaluation p_{i,k}_{^{o}}_{,k}_{^{lg}}:=pᵢ(q_{i,k}_{^{o}}^{o},q_{i,k}_{^{lg}}^{lg}) of the outlet pressure will preferably be performed in each combination of those points described as

$${p}_{i} = {\sum }_{{k}^{o} ∈ {K}_{i}^{o}} {\sum }_{{k}^{lg} ∈ {K}_{i}^{lg}} {p}_{i , {k}^{o} , {k}^{lg}} {λ}_{i , {k}^{o} , {k}^{lg}} ∀ i ∈ W \qquad ( 2 )$$

Said model should also include the oil and lift gas rates. To add these rates auxiliary variables are preferably defined as

$$\begin{matrix}{λ}_{i , {k}^{o}}^{o} = {\sum }_{{k}^{lg} ∈ {K}_{i}^{lg}} {λ}_{i , {k}^{o} , {k}^{lg}} ∀ i ∈ W , {k}^{o} ∈ {K}_{i}^{o} & ( 3 ) \\ {λ}_{i , {k}^{lg}}^{lg} = {\sum }_{{k}^{o} ∈ {K}_{i}^{o}} {λ}_{i , {k}^{o} {k}^{lg}} ∀ i ∈ W , {k}^{lg} ∈ {K}_{i}^{lg} & ( 4 )\end{matrix}$$

Using these variables, the oil and lift gas rates can preferably be included as

$$\begin{matrix}{q}_{i}^{o} = {\sum }_{{k}^{o} ∈ {K}_{i}^{o}} {q}_{i , {k}^{o}}^{o} {λ}_{i , {k}^{o}} ∀ i ∈ W , {k}^{o} ∈ {K}_{i}^{o} & ( 5 ) \\ {q}_{i}^{lg} = {\sum }_{{k}^{lg} ∈ {K}_{i}^{lg}} {q}_{i , {k}^{lg}}^{lg} {λ}_{i , {k}^{lg}} ∀ i ∈ W , {k}^{lg} ∈ {K}_{i}^{lg} & ( 6 )\end{matrix}$$

The gas and water rates will also be suitable and preferably defined as

$$\begin{matrix}{q}_{i}^{g} = {\sum }_{{k}^{o} ∈ {K}_{i}^{o}} {r}_{i}^{g} {q}_{i , {k}^{o}}^{o} {λ}_{i , {k}^{o}} ∀ i ∈ W , {k}^{o} ∈ {K}_{i}^{o} & ( 7 ) \\ {q}_{i}^{w} = {\sum }_{{k}^{o} ∈ {K}_{i}^{o}} {r}_{i}^{w} {q}_{i , {k}^{o}}^{o} {λ}_{i , {k}^{o}} ∀ i ∈ W , {k}^{o} ∈ {K}_{i}^{o} & ( 8 )\end{matrix}$$

where rᵢ^{g} is the gas oil ratio and rᵢ^{w} is the water oil ratio (i.e. rᵢ^{w}:=WCᵢ/(1−WCᵢ) where WCᵢ is the water cut of the well). Furthermore, the convexity constraints may be added as

$$\begin{matrix}{\sum }_{{k}^{o} ∈ {K}_{i}^{o}} {\sum }_{{k}^{lg} ∈ {K}_{i}^{lg}} {λ}_{i , {k}^{o} , {k}^{lg}} = 1 ∀ i ∈ W & ( 9 ) \\ {λ}_{i , {k}^{o} , {k}^{lg}} \geq 0 ∀ i ∈ W , {k}^{o} ∈ {K}_{i}^{o} , {k}^{lg} ∈ {K}_{i}^{lg} & ( 10 )\end{matrix}$$

To ensure that neighbors are used in the interpolation, two more constrains have to be added as:

For each i,at most two λ_{i,k}_{^{o}}^{o} may be positive,and they must be adjacent. (11)

For each i,at most two λ_{i,k}_{^{lg}}^{lg} may be positive,and they must be adjacent. (12)

The conditions (11)-(12) are preferably enforced in the optimization problem by using specialized constraints supported by an implementation of the branch and bound method. An example of such specialized constraints includes special ordered set of type 2. According to an alternative embodiment, the conditions are enforced by the use of additional integer decision variables.

According to an alternative embodiment, the piecewise affine approximation of a well 13, 14 males use of the outlet pressure of the well as an independent variable, and a reservoir pressure as a dependent variable.

### Flow Lines

A model of an upstream flow line 24 or downstream flow line 15, preferably, relates the volumetric oil rates, gas lift rates, and outlet pressure of the flow line 24, 15, for example the manifold 20 pressure and/or production separator 1 pressure. The outlet pressure of the flow line 15, 24 will be described by piecewise affine functions that are approximated. Thus, the expression

pᵢ=pᵢ(qᵢ^{o},qᵢ^{g},qᵢ^{w},pᵢ^{I})∀iεF (13)

is modeled, where qᵢ^{g} is the gas rate, qᵢ^{w} is the water rate, and pᵢ^{I} is the inlet pressure of the flow line. The outlet pressure can be defined as

$${p}_{i} = {\sum }_{{k}^{o} ∈ {K}_{i}^{o}} {\sum }_{{k}^{g} ∈ {K}_{i}^{g}} {\sum }_{{k}^{w} ∈ {K}_{i}^{w}} {\sum }_{{k}^{p} ∈ {K}_{i}^{p}} {p}_{i , {k}^{o} , {k}^{g} , {k}^{w} , {k}^{p}} {λ}_{i , {k}^{o} , {k}^{g} , {k}^{w} , {k}^{p}} ∀ i ∈ F \qquad ( 14 )$$

Auxiliary variables are preferably then defined

$$\begin{matrix}{λ}_{i , {k}^{o}}^{o} = {\sum }_{{k}^{g} ∈ {K}_{i}^{g}} {\sum }_{{k}^{w} ∈ {K}_{i}^{w}} {\sum }_{{k}^{p} ∈ {K}_{i}^{p}} {λ}_{i , {k}^{o} , {k}^{g} , {k}^{w} , {k}^{p}} ∀ i ∈ F , {k}^{o} ∈ {K}_{i}^{o} & ( 15 ) \\ {λ}_{i , {k}^{g}}^{g} = {\sum }_{{k}^{o} ∈ {K}_{i}^{o}} {\sum }_{{k}^{w} ∈ {K}_{i}^{w}} {\sum }_{{k}^{p} ∈ {K}_{i}^{p}} {λ}_{i , {k}^{o} , {k}^{g} , {k}^{w} , {k}^{p}} ∀ i ∈ F , {k}^{g} ∈ {K}_{i}^{g} & ( 16 ) \\ {λ}_{i , {k}^{w}}^{w} = {\sum }_{{k}^{o} ∈ {K}_{i}^{o}} {\sum }_{{k}^{g} ∈ {K}_{i}^{g}} {\sum }_{{k}^{p} ∈ {K}_{i}^{p}} {λ}_{i , {k}^{o} , {k}^{g} , {k}^{w} , {k}^{p}} ∀ i ∈ F , {k}^{w} ∈ {K}_{i}^{w} & ( 17 ) \\ {λ}_{i , {k}^{p}}^{p} = {\sum }_{{k}^{o} ∈ {K}_{i}^{o}} {\sum }_{{k}^{g} ∈ {K}_{i}^{g}} {\sum }_{{k}^{w} ∈ {K}_{i}^{w}} {λ}_{i , {k}^{o} , {k}^{g} , {k}^{w} , {k}^{p}} ∀ i ∈ F , {k}^{p} ∈ {K}_{i}^{p} & ( 18 )\end{matrix}$$

Using these variables, oil, gas, water, and inlet pressure can preferably be included as

$$\begin{matrix}{q}_{i}^{o} = {\sum }_{{k}^{o} ∈ {K}_{i}^{o}} {q}_{i , {k}^{o}}^{o} {λ}_{i , {k}^{o}}^{o} ∀ i ∈ F , {k}^{o} ∈ {K}_{i}^{o} & ( 19 ) \\ {q}_{i}^{g} = {\sum }_{{k}^{g} ∈ {K}_{i}^{g}} {q}_{i , {k}^{o}}^{g} {λ}_{i , {k}^{g}}^{g} ∀ i ∈ F , {k}^{g} ∈ {K}_{i}^{g} & ( 20 ) \\ {q}_{i}^{w} = {\sum }_{{k}^{w} ∈ {K}_{i}^{w}} {q}_{i , {k}^{w}}^{w} {λ}_{i , {k}^{w}}^{w} ∀ i ∈ F , {k}^{w} ∈ {K}_{i}^{w} & ( 21 ) \\ {p}_{i}^{I} = {\sum }_{{k}^{lg} ∈ {K}_{i}^{lg}} {p}_{i , {k}^{p}}^{I} {λ}_{i , {k}^{p}}^{p} ∀ i ∈ F , {k}^{p} ∈ {K}_{i}^{p} & ( 22 )\end{matrix}$$

Furthermore, the convexity constraints are added in a similar way as above,

$$\begin{matrix}{\sum }_{{k}^{o} ∈ {K}_{i}^{o}} {\sum }_{{k}^{g} ∈ {K}_{i}^{g}} {\sum }_{{k}^{w} ∈ {K}_{i}^{w}} {\sum }_{{k}^{p} ∈ {K}_{i}^{p}} {λ}_{i , {k}^{o} , {k}^{g} , {k}^{w} , {k}^{p}} = 1 ∀ i ∈ F & ( 23 ) \\ {λ}_{i , {k}^{o} , {k}^{g} , {k}^{w} , {k}^{p}} \geq 0 ∀ i ∈ F , {k}^{o} ∈ {K}_{i}^{o} , \\ {k}^{g} ∈ {K}_{i}^{g} , {k}^{w} ∈ {K}_{i}^{w} , {k}^{p} ∈ {K}_{i}^{p} & ( 24 )\end{matrix}$$

To ensure that neighbors are used in the interpolation, the following addition constrains are added

For each i,at most two λ_{i,k}_{^{o}}^{o} may be positive,and they must be adjacent. (25)

For each i,at most two λ_{i,k}_{^{g}}^{g} may be positive,and they must be adjacent. (26)

For each i,at most two λ_{i,k}_{^{w}}^{w} may be positive,and they must be adjacent. (27)

For each i,at most two λ_{i,k}_{^{p}}^{p} may be positive,and they must be adjacent. (28)

The conditions (25)-(28) are preferably enforced in the optimization problem by the use of a special ordered set of type 2 for each condition. According to an alternative embodiment, the conditions are enforced by the use of additional integer decision variables.

According to an alternative embodiment, the piecewise affine approximation of a flow line 15, 24 uses the outlet pressure of the flow line as an independent variable, and the inlet pressure of said flow line as a dependent variable.

### Choke

The minimal pressure drop of the chokes 7, 8, 9 will be included in the outlet pressure pᵢ of a well 13, 14 and/or flow line 15, 24. This minimal pressure drop is found by including the choke model hi the calculation of the pressure drop in the well and/or flow line with a choke opening set to its maximal opening, typically position 1.0. Any reduction of the choke opening will give a higher pressure drop, thus for any well or flow lines iεW∪F with a choke

pᵢ^{O}≦pᵢ (29)

If a choke does not exist, the pressure equality

pᵢ^{O}=pᵢ. (30)

is used.

It should be noted that the above statement is only true if the flow direction is given. If the flow changes direction, then the additional pressure drop will have opposite sign.

### Outlet Boundary

It is preferred that a model of a production separator 1 is included in the model. The preferred model is at a fixed pressure condition. Preferably, this outlet boundary i has a fixed inlet pressure pᵢ^{I} for all iεO where O is the set of outlet boundary nodes.

### Connection

The inlet of a downstream flow line 15 is connected to at least one well 13,14 or upstream flow line 24. Let i be a reference to downstream flow line 15. The mass balance is then enforced by

$$\begin{matrix}{q}_{i}^{o} = {\sum }_{j ∈ {Ω}_{i}} {q}_{j}^{o} ∀ i ∈ F ⋃ B , & ( 31 ) \\ {q}_{i}^{g} = {\sum }_{j ∈ {Ω}_{i}} {q}_{j}^{g} ∀ i ∈ F ⋃ B , & ( 32 ) \\ {q}_{i}^{w} = {\sum }_{j ∈ {Ω}_{i}} {q}_{j}^{w} ∀ i ∈ F ⋃ B . & ( 33 )\end{matrix}$$

and the pressure equality at the node by

pᵢ^{I}=pⱼ^{O}∀iεF∪B,jεΩᵢ (34)

where Ωᵢ is the set of at least one upstream flow line 24 and/or well 13,14 connected to the inlet of a downstream flow line 15 or an outlet boundary, such as a production separator 1.

### Objective

The objective is preferably to maximize the total oil production rate, which can be formulated as

$$max {\sum }_{i ∈ B} {q}_{i}^{o} . \qquad ( 35 )$$

This assumes that all production ends in an outlet boundary denoted iεB. The part

$${\sum }_{i ∈ B} {q}_{i}^{o}$$

is called the objective function, which is a computational function that is maximized by adjusting the decision variables qᵢ^{o} within the constraints defined by the equalities or inequalities.

### Constraints

The stated optimization problem is preferably incorporated with constraints on flow rates and pressures of the well, upstream flow lines and/or downstream flow lines as

qᵢ^{o}≦ q̅ᵢ^{o}∀iεW∪F∪B, (36)

q₁^{g}≦ q̅ᵢ^{g}∀iεW∪F∪B, (37)

qᵢ^{w}≦ q̅ᵢ^{w}∀iεW∪F∪B, (38)

qᵢ^{w}+qᵢ^{o}≦ q̅ᵢ^{l}∀iεW∪F∪B. (39)

and for the pressure there is an upper bound

pᵢ^{o}≦ p̅ᵢ^{o}∀iεW∪F∪B (40)

where p̅ᵢ^{o} denote the maximal outlet pressure and a lower bound

pᵢ^{o}≧pᵢ^{o}∀iεW∪F∪B. (41)

### Branch and Bound

An optimization problem is defined by the objective function and a feasible set or region for the associated decision variables. The feasible set is typically defined by constraints, e.g. inequalities, equalities or integer requirements associated with the decision variables. Both the feasible set and the objective function are defined on the same decision variables. The decision variable denotes a vector of scalar real variables. The optimization problem is solved by finding a value of the decision variable within said feasible set that maximizes or minimizes said objective function. This means that it does not exist a value of the decision variable (within the feasible set) which gives higher or lower value of the objective function, respectively.

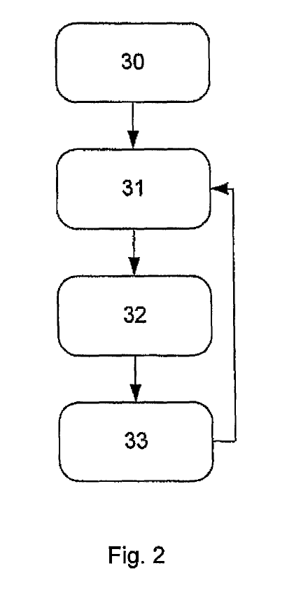

The optimization problem above is preferably solved using a branch and bound method. A data flow of a preferred embodiment is shown in FIG. 2. The method works by globally solving a relaxation of said optimization problem. A relaxation is typically an optimization problem on a feasible set which includes at least all the points of the original feasible set, and where the associated objective function is guaranteed not to be worse than the original objective function in any points within said feasible set. Thus, by solving said relaxed problem, a best bound on the objective function for said optimization problem can be found. Best bound means an upper bound or limit for maximization problems and lower bound or limit for minimization problems of the objective function. Worst bound means the opposite. A worst bound is preferably found by calculating the value of the (original) objective function for a value of the decision variable in the (original) feasible set. For the relaxed optimization problem, a value of said decision variable is found. Typically the solution value for the decision variable of the relaxed problem is used as a candidate for calculation of the worst bound. The process of calculating best/worst bounds is called bounding 33.

By using the value of the decision variable found by solving the relaxed problem, the feasible set is preferably split, preferably using a calculation, into at least two new subsets. Preferably, the number of subsets is two. Typically, said value is used to select the new subsets. Preferably, the intersection of these subsets is empty, but it is not a requirement. The process of splitting is called branching 31.

For each of the subsets the bounding procedure 33 described above is carried out. In a preferred embodiment, the relaxed optimization problem of the subset is constructed such that best bound will not increase for maximization or not decrease for minimization compared to the relaxed optimization problem of the feasible set.

Preferably, the method initializes 30 the best bound and worst bound before using them in subsequent steps 31, 32, 33.

The method is preferably terminated when the difference between the worst bound and best bound is less than some predetermined value.

The method preferably carries out branching on a subset which has a best bound that is higher for maximization or lower for minimization than the existing worst bound. This is often referred to as pruning.

If not terminated, at least one out of the subsets is preferably split, preferably using a calculation, (as in 31) into further subsets. The method continues by repeating the said steps on the newly calculated subsets.

In the preferred embodiment, piecewise affine approximations, as defined in the model above, are used. These are computational modeled using discrete constraints on decision variables. Examples of such include a decision variable that may be either zero or one, or which two variables interpolation between. Typically, a constraint that is violated in the value found by the relaxed optimization problem is used for branching. Preferably, if the zero or one variable is 0.5, then it is set to zero and one in each new branch, respectively. For interpolation, this is preferably done by excluding some invalid interpolations in each new subset.

Preferably, the relaxed optimization problem is a convex optimization problem. Further, it is preferred that a global optimum can be found by the relaxed optimization problem.

The method according to the present invention may be implemented as software, hardware, or a combination thereof. A computer program product implementing the method or a part thereof comprises software or computer program, run on a general purpose or specially adapted computer, processor or microprocessor. The software includes computer program code elements or software code portions that make the computer perform the method using at least one of the steps according to the inventive method.

The program may be stored in whole or part, on, or in, one or more suitable computer readable media or data storage means such as a magnetic disk, CD-ROM or DVD disc, hard drive, magneto-optical memory storage means, in RAM or volatile memory, in ROM or flash memory, as firmware, or on a data server.

The invention is of course not in any way restricted to the embodiments described above. On the contrary, many possibilities to modifications thereof will be apparent to a person skilled in the art without departing from the basic idea of the invention such as defined in the appended claims.

1. A method for production optimization in an oil and/or a gas production system comprising:
at least two flow sources leading to at least one common downstream flow line, and at least one manipulated variable of the production system,
wherein the method comprises use of:
a computational model of the production system comprising an interdependence between flow rates of said flow sources and a flow rate of said downstream flow line, and values of said manipulated variable,
a feasible set defined by at least one constraint of said manipulated variable, and
an objective function, to be optimized within said feasible set, defined by using said computational model,
the method comprising:
splitting by calculation said feasible set into at least two subsets,
calculating, for each of said subsets, a best bound of said objective function by using said computational model, and
manipulating said manipulated variable by using said best bound to optimise said oil and/or gas production.

2. The method according to claim 1, wherein a worst bound of said objective function within said feasible set is calculated using a value within said feasible set.

3. The method according to claim 2, wherein the method is terminated when the difference between said worst bound and said best bound is less than a predetermined value.

4. The method according to claim 1, wherein said best bound is calculated using a relaxation of said objective function, said feasible set and/or at least one of said subsets.

5. The method according to claim 1, wherein a pressure is approximated in said computational model using at least one of said flow rates.

6. The method according to claim 5, wherein said pressure is at a point where flows from said flow sources are blended.

7. The method according to claim 1, wherein said computational model is piecewise affine.

8. The method according to claim 1, further comprising:
further splitting by calculation at least one of said subsets into additional subsets using said best bound.

9. The method according to claim 1, wherein said objective function uses at least one of said flow rates.

10. The method according to claim 1, wherein at least one of said flow sources is a well.

11. The method according to claim 1, wherein at least one of said flow sources is an upstream flow line.

12. The method according to claim 1, wherein the method includes a constraint on a flow rate, a choke opening, a control valve opening, a pressure, a temperature, a fluid composition, fluid velocity, pump load or speed, compressor load or speed, or hydrocyclone load.

13. The method according to claim 1, wherein a choke or valve is used for the purpose of controlling a flow and/or a pressure of said downstream flow line or at least one of said sources.

14. The method according to claim 13, wherein the method is used to manipulate said choke or valve.

15. The method according to claim 1, wherein said oil and/or gas production system comprises a subsea template at which well flows are blended at the seabed.

16. The method according to claim 1, wherein said oil and/or gas production system comprises:
a supply of lift gas to supply lift gas into a well.

17. The method according to claim 16, wherein said method is used to manipulate said supply of lift gas.

18. A system for optimization an oil and/or a gas production comprising:
at least two flow sources leading to at least one common downstream flow line, and means for providing at least one manipulated variable of the production system,
means for providing a computational model of the production system comprising an interdependence between flow rates of said flow sources and a flow rate of said downstream flow line, and values of said manipulated variable,
means for providing a feasible set defined by at least one constraint of said manipulated variable, and
means for providing an objective function, to be optimized within said feasible set, defined by using said computational model,
characterized in that said system comprises: means for
splitting by calculation said feasible set into at least two subsets,
calculating, for each of said subsets, a best bound of said objective function by using said computational model, and
means for manipulating said manipulated variable by using said best bound to optimise said oil and/or gas production.

19. A computer program product, comprising:
a computer readable medium; and
computer program instruction recorded on the computer readable medium and executable by a processor for carrying out a method for production optimization in an oil and/or a gas production system
the system comprising at least two flow sources leading to at least one common downstream flow line, and at least one manipulated variable of the production system,
the method comprising:
utilizing of a computational model of the production system comprising an interdependence between flow rates of said flow sources and a flow rate of said downstream flow line, and values of said manipulated variable, a feasible set defined by at least one constraint of said manipulated variable, and an objective function, to be optimized within said feasible set, defined by using said computational model,
splitting by calculation said feasible set into at least two subsets,
calculating, for each of said subsets, a best bound of said objective function by using said computational model, and
manipulating said manipulated variable by using said best bound to optimise said oil and/or gas production.

20. (canceled)
